(19) United States
(12) Patent Application Publication
(10) Pub. No.: US 2026/0188313 A1
(43) Pub. Date: Jul. 2, 2026

(54) MIXED REALITY DEVICE-BASED SPEECH ASSISTANCE

(71) Applicant: Meta Platforms Technologies, LLC, Menlo Park, CA (US)

(72) Inventors: Bina Thakkar, Cary, NC (US); Fan Zhang, Kirkland, WA (US); David Frederick Geisert, London (GB); Erica Jean Virtue, New York, NY (US)

(21) Appl. No.: 19/003,989

(22) Filed: Dec. 27, 2024

(51) Int. Cl. G10L 15/22; G06F 3/01; G10L 13/04; G10L 15/26

(52) U.S. Cl. CPC G10L 15/22; G06F 3/013; G10L 13/04; G10L 15/26

(57) ABSTRACT

An embodiment includes causing generating, using a trained large language model (LLM), a plurality of candidate responses to a first portion of audio content. An embodiment includes receiving a selection of a candidate response in the plurality of candidate responses. An embodiment includes causing generating, using a trained text-to-speech model, a second portion of audio content, wherein the second portion of audio content comprises a spoken version of the selected candidate response.

### TECHNICAL FIELD

The present disclosure generally relates to mixed reality devices, and more particularly to mixed reality device-based speech assistance.

### BACKGROUND

The term “mixed reality” or “MR,” as used herein, refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR,” as used herein, refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

Speech assistance, as used herein, refers to assisting a user to communicate via speech with others. Some speech assistance users have a hearing loss or a voice, speech, or language disorder. Other speech assistance users may be in a situation in which speech is difficult for another reason (e.g., in an environment where speech is discouraged or when speech translation is desired). For example, a user with hearing loss or a language processing disorder might use speech-to-text transcription to understand what others are saying, or a user with a speech production disorder might communicate via text or enter text into a text-to-speech application. However, existing speech assistance applications require a device with a sufficiently large display screen or text-entry method (e.g., a mobile device), and their use is often obtrusive. Thus, there is a need for mixed reality device-based speech assistance, executing on a less obtrusive device such as an MR headset implemented in a pair of eyeglasses.

### SUMMARY

Some embodiments of the present disclosure provide a computer-implemented method for mixed reality device-based speech assistance. The method includes causing generating, using a trained large language model (LLM), a plurality of candidate responses to a first portion of audio content; receiving a selection of a candidate response in the plurality of candidate responses; and causing generating, using a trained text-to-speech model, a second portion of audio content, wherein the second portion of audio content comprises a spoken version of the selected candidate response.

Some embodiments of the present disclosure provide a non-transitory computer-readable medium storing a program for mixed reality device-based speech assistance. The program, when executed by a computer, configures the computer to cause generating, using a trained large language model (LLM), a plurality of candidate responses to a first portion of audio content; receive a selection of a candidate response in the plurality of candidate responses; and cause generating, using a trained text-to-speech model, a second portion of audio content, wherein the second portion of audio content comprises a spoken version of the selected candidate response.

Some embodiments of the present disclosure provide a system for mixed reality device-based speech assistance. The system comprises a processor and a non-transitory computer-readable medium storing a set of instructions, which when executed by the processor, configure the processor to cause generating, using a trained large language model (LLM), a plurality of candidate responses to a first portion of audio content; receive a selection of a candidate response in the plurality of candidate responses; and cause generating, using a trained text-to-speech model, a second portion of audio content, wherein the second portion of audio content comprises a spoken version of the selected candidate response.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement mixed reality device-based speech assistance, according to some embodiments.

FIG. 2 is a block diagram illustrating details of a system for mixed reality device-based speech assistance, according to some embodiments.

FIG. 3 depicts a block diagram of an example configuration for mixed reality device-based speech assistance, in accordance with an illustrative embodiment.

FIG. 4 depicts an example of mixed reality device-based speech assistance, in accordance with an illustrative embodiment.

FIG. 5 depicts another example of mixed reality device-based speech assistance, in accordance with an illustrative embodiment.

FIG. 6 depicts an example of contents of a display used in mixed reality device-based speech assistance, in accordance with an illustrative embodiment.

FIG. 7 depicts another example of contents of a display used in mixed reality device-based speech assistance, in accordance with an illustrative embodiment.

FIG. 8 depicts a flowchart of an example process for mixed reality device-based speech assistance, in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing mixed reality device-based speech assistance. In particular, an embodiment causes generating, using a trained large language model (LLM), of a plurality of candidate responses to a first portion of audio content; receives a selection of a candidate response in the plurality of candidate responses; and causes generating, using a trained text-to-speech model, of a second portion of audio content, wherein the second portion of audio content comprises a spoken version of the selected candidate response.

An embodiment uses a trained speech-to-text model to generate a text transcription of a portion of audio content and displays the generated text transcription concurrently with the transcription's generation. Techniques to detect audio content (e.g., using a microphone in an AR headset or mobile device) are presently available. Trained speech-to-text models, for use on human languages such as English, are also presently available. One embodiment executes a trained speech-to-text model on one or more processors in an AR headset and displays the resulting transcription on a display of the AR headset. For example, if the AR headset is in a glasses format, an embodiment might display the transcription on a portion of the display, leaving other portions of the display available for viewing other generated content such as transcription controls and other portions of the display allowing the user to view the real world through the glasses. As another example, if the AR headset is in a VR headset format, an embodiment might display the transcription on a portion of the display, leaving other portions of the display available for viewing other generated content such as transcription controls and other portions of the display showing generated passthrough content, i.e., content portraying the real world as if the user was seeing the world directly. Another embodiment executes a trained speech-to-text model on one or more processors in a mobile device or other computer system and displays the resulting transcription on a display of the device or on another display. Another embodiment, executing on an AR headset or other device that lacks sufficient processing power to perform speech to text generation sufficiently quickly (e.g., in real time or quickly enough to assist in in-person conversation between an AR headset user and another person), uses a presently available telecommunications technique to send the audio content to a trained speech-to-text model executing on another computer system, which sends a transcription back to the embodiment for display on the AR headset.

In some embodiments, the trained text-to-speech model is trained to generate text in a first human language from input audio content in a second human language, and thus the text transcription is in the second language. For example, the input audio content might be in English, and the trained text-to-speech model generates a transcription in French.

Along with the text transcription, some embodiments display additional user interface elements with which a user can control aspects of an embodiment's operation. For example, one user interface element might turn transcription on or off, and another user interface element might remove a transcription from the display.

An embodiment uses a trained LLM to generate one or more candidate responses to the transcribed audio content. An LLM is a presently available technique, typically implemented in an artificial neural network, that is designed for natural language processing tasks such as language generation. LLMs acquire the ability to perform natural language processing tasks by learning statistical relationships from text documents during a self-supervised and semi-supervised training process. In some embodiments, the LLM has access to a database or compendium of public data with which to generate candidate responses. In some embodiments, the LLM also has access to a database or compendium of non-public data, such as the user's calendar or conversation history with one or more other users, with which to generate candidate responses.

In some embodiments, the LLM executes on the same system (e.g., an AR headset or mobile device) as the display to a user. In other embodiments in which the display system lacks sufficient processing or memory capacity to execute an LLM sufficiently quickly (e.g., in real time or quickly enough to assist in in-person conversation between an AR headset user and another person), an embodiment uses a presently available telecommunications technique to send the transcription to a trained LLM executing on another computer system, which sends candidate responses back to the embodiment for display to the user (e.g., on an AR headset or mobile device). In some embodiments, the candidate responses include one or more default responses that a user might use regardless of the audio content or if the audio content could not be processed sufficiently quickly. For example, one default response might explain that the user is using an assistive application, and another default response might ask for patience while the user composes a response.

An embodiment receives a selection of a candidate response in the plurality of candidate responses. In some embodiments, a user performs the selection using a presently available user interface technique. For example, a mobile device user might tap a particular portion of the device's display to indicate a selection, a desktop device user might use a mouse or touchpad to click on a particular portion of the device's display to indicate a selection, or an AR headset wearer might stare at a particular portion of the AR content for a predetermined amount of time and pinch a finger and thumb together to indicate a selection of the user interface element being looked at. An AR headset typically includes one or more cameras capable of detecting a user's eye movements, where a user is looking and for how long, and a user's finger motions. Other user interface element implementations are also possible and contemplated within the scope of the illustrative embodiments.

In another embodiment, a user has the option of rejecting the plurality of candidate responses and requesting a new plurality of candidate responses to select from. In another embodiment, a user has the option of composing a response via a presently available user interface (e.g., a virtual keyboard displayed on a mobile device or as virtual content on an AR headset), either by editing a candidate response or starting from scratch.

An embodiment uses a trained text-to-speech model to generate a second portion of audio content comprising a spoken version of the selected candidate response. Trained text-to-speech models, for use on human languages, are presently available. In one embodiment, the trained speech-to-text model includes a translation capability, and the selected candidate response is translated from one human language to another. For example, if the input audio content was in English and transcription was in French, the candidate responses might also be in French and the corresponding audio translated into English.

One embodiment executes a trained text-to-speech model on the device used to display text to a user. Another embodiment sends a selected candidate response to another device, which executes a trained text-to-speech model and returns resulting audio to the embodiment. An embodiment plays the audio content, using a speaker on the device used to display text to a user or using a speaker on a different device. For example, playing audio on a speaker on an AR headset, at a volume loud enough for a nearby person to hear, might be uncomfortably loud for a wearer of the AR headset, and thus another device (e.g., a mobile device of the headset wearer) is used instead.

Another embodiment uses a trained avatar generation model, a presently available technique, to generate a portion of video content that includes an avatar portrayed as speaking the selected candidate response. For example, a user might use an avatar portrayed as speaking the selected candidate response when a user is communicating using a conferencing application with audio and video.

Another embodiment omits the audio generation of the selected candidate response, and instead uses a presently available technique to send the response in text form (e.g., as a text message, social media message, or email message) to another user.

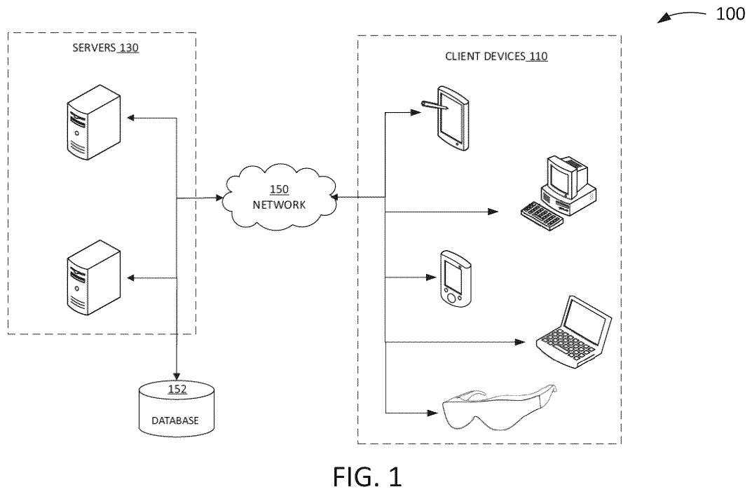

FIG. 1 illustrates a network architecture 100 used to implement mixed reality device-based speech assistance, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

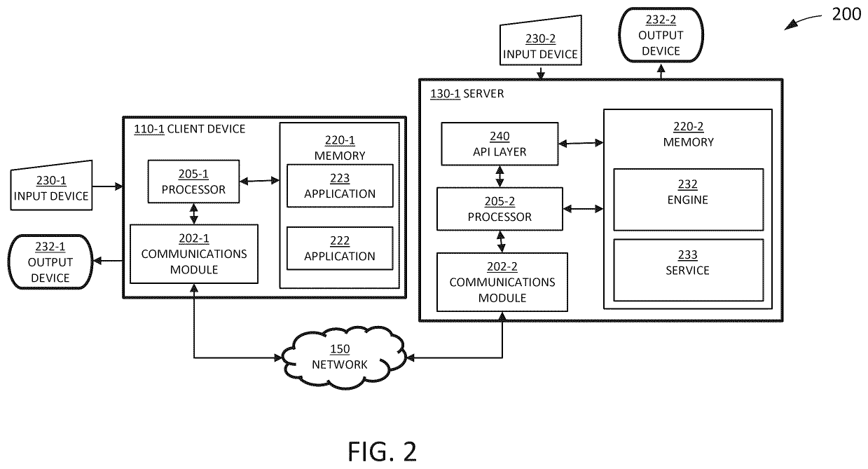

FIG. 2 is a block diagram illustrating details of a system 200 for mixed reality device-based speech assistance, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement mixed reality device-based speech assistance. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide mixed reality device-based speech assistance. The application 223 may communicate with service 233 through API layer 240, for example.

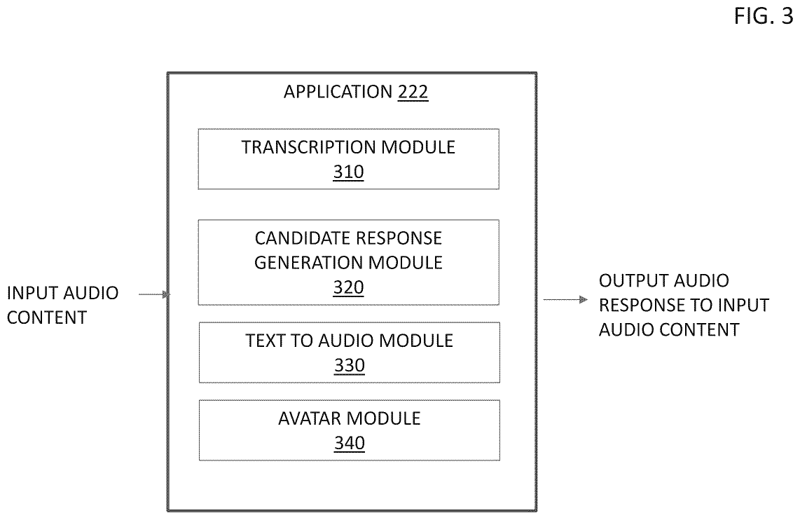

FIG. 3 depicts a block diagram of an example configuration for mixed reality device-based speech assistance, in accordance with an illustrative embodiment. Application 222 is the same as application 222 in FIG. 2.

Transcription module 310 uses a trained speech-to-text model to generate a text transcription of a portion of audio content and displays the generated text transcription concurrently with the transcription's generation. Techniques to detect audio content (e.g., using a microphone in an AR headset or mobile device) are presently available. Trained speech-to-text models, for use on human languages such as English, are also presently available. One implementation of module 310 executes a trained speech-to-text model on one or more processors in an AR headset and displays the resulting transcription on a display of the AR headset. For example, if the AR headset is in a glasses format, module 310 might display the transcription on a portion of the display, leaving other portions of the display available for viewing other generated content such as transcription controls and other portions of the display allowing the user to view the real world through the glasses. As another example, if the AR headset is in a VR headset format, module 310 might display the transcription on a portion of the display, leaving other portions of the display available for viewing other generated content such as transcription controls and other portions of the display showing generated passthrough content, i.e., content portraying the real world as if the user was seeing the world directly. Another implementation of module 310 executes a trained speech-to-text model on one or more processors in a mobile device or other computer system and displays the resulting transcription on a display of the device or on another display. Another implementation of module 310, executing on an AR headset or other device that lacks sufficient processing power to perform speech to text generation sufficiently quickly (e.g., in real time or quickly enough to assist in in-person conversation between an AR headset user and another person), uses a presently available telecommunications technique to send the audio content to a trained speech-to-text model executing on another computer system, which sends a transcription back to the embodiment for display on the AR headset.

In some implementations of module 310, the trained text-to-speech model is trained to generate text in a first human language from input audio content in a second human language, and thus the text transcription is in the second language. For example, the input audio content might be in English, and the trained text-to-speech model generates a transcription in French.

Along with the text transcription, some implementations of application 222 display additional user interface elements with which a user can control aspects of an embodiment's operation. For example, one user interface element might turn transcription on or off, and another user interface element might remove a transcription from the display.

Candidate response generation module 320 uses a trained LLM to generate one or more candidate responses to the transcribed audio content. An LLM is a presently available technique, typically implemented in an artificial neural network, that is designed for natural language processing tasks such as language generation. LLMs acquire the ability to perform natural language processing tasks by learning statistical relationships from text documents during a self-supervised and semi-supervised training process. In some implementations of module 320, the LLM has access to a database or compendium of public data with which to generate candidate responses. In some implementations of module 320, the LLM also has access to a database or compendium of non-public data, such as the user's calendar, conversation history with one or more other users, with which to generate candidate responses.

In some implementations of module 320, the LLM executes on the same system (e.g., an AR headset or mobile device) as the display to a user. In other implementations of module 320 in which the display system lacks sufficient processing or memory capacity to execute an LLM sufficiently quickly (e.g., in real time or quickly enough to assist in in-person conversation between an AR headset user and another person), module 320 uses a presently available telecommunications technique to send the transcription to a trained LLM executing on another computer system, which sends candidate responses back to the embodiment for display to the user (e.g., on an AR headset or mobile device). In some implementations of module 320, the candidate responses include one or more default responses that a user might use regardless of the audio content or if the audio content could not be processed sufficiently quickly. For example, one default response might explain that the user is using an assistive application, and another default response might ask for patience while the user composes a response.

Text to audio module 330 receives a selection of a candidate response in the plurality of candidate responses. In some implementations of module 330, a user performs the selection using a presently available user interface technique. For example, a mobile device user might tap a particular portion of the device's display to indicate a selection, a desktop device user might use a mouse or touchpad to click on a particular portion of the device's display to indicate a selection, or an AR headset wearer might stare at a particular portion of the AR content for a predetermined amount of time and pinch a finger and thumb together to indicate a selection of the user interface element being looked at. An AR headset typically includes one or more cameras capable of detecting a user's eye movements, where a user is looking and for how long, and a user's finger motions. Other user interface element implementations are also possible.

In another implementation of module 330, a user has the option of rejecting the plurality of candidate responses and requesting a new plurality of candidate responses to select from. In another implementation of module 330, a user has the option of composing a response via a presently available user interface (e.g., a virtual keyboard displayed on a mobile device or as virtual content on an AR headset), either by editing a candidate response or starting from scratch.

Module 330 uses a trained text-to-speech model to generate a second portion of audio content comprising a spoken version of the selected candidate response. Trained text-to-speech models, for use on human languages, are presently available. In one implementation of module 330, the trained speech-to-text model includes a translation capability, and the selected candidate response is translated from one human language to another. For example, if the input audio content was in English and transcription was in French, the candidate responses might also be in French and the corresponding audio translated into English.

One implementation of module 330 executes a trained text-to-speech model on the device used to display text to a user. Another implementation of module 330 sends a selected candidate response to another device, which executes a trained text-to-speech model and returns resulting audio to the embodiment. Module 330 plays the audio content, using a speaker on the device used to display text to a user or using a speaker on a different device. For example, playing audio on a speaker on an AR headset, at a volume loud enough for a nearby person to hear, might be uncomfortably loud for a wearer of the AR headset, and thus another device (e.g., a mobile device of the headset wearer) is used instead.

In another implementation of application 222, avatar generation module 340 uses a trained avatar generation model, a presently available technique, to generate a portion of video content that includes an avatar portrayed as speaking the selected candidate response. For example, a user might use an avatar portrayed as speaking the selected candidate response when a user is communicating using a conferencing application with audio and video.

Another implementation of application 222 omits the audio generation of the selected candidate response, and instead uses a presently available technique to send the response in text form (e.g., as a text message, social media message, or email message) to another user.

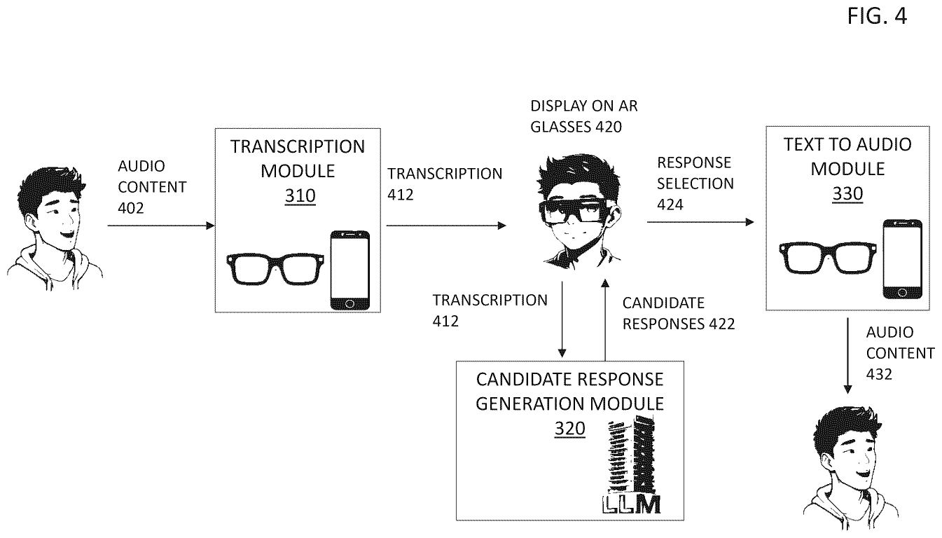

FIG. 4 depicts an example of mixed reality device-based speech assistance, in accordance with an illustrative embodiment. The example can be executed using application 222 in FIG. 2. Transcription module 310, candidate response generation module 320, and text to audio module 330 are the same as transcription module 310, candidate response generation module 320, and text to audio module 330 in FIG. 3.

As depicted, transcription module 310, executing in this example on AR glasses or a mobile device, generates transcription 412 from audio content 402. Transcription 412 is displayed on AR glasses 420 and sent to candidate response generation module 320. Candidate response generation module 320 uses an LLM to generate candidate responses 422, which are also displayed on AR glasses 420. Text to audio module 330, executing in this example on AR glasses or a mobile device, receives response selection 424 and generates audio content 432, which is audible to the person who spoke audio content 402.

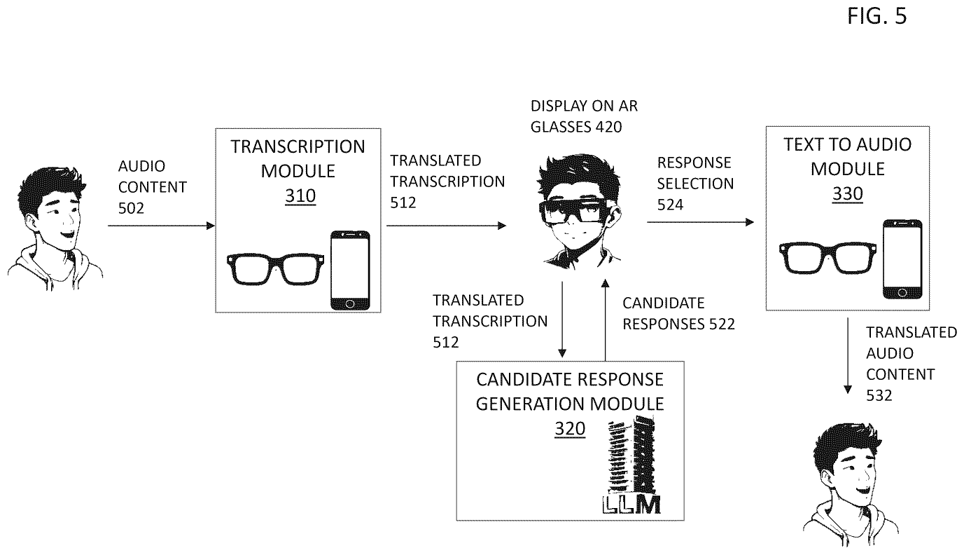

FIG. 5 depicts another example of mixed reality device-based speech assistance, in accordance with an illustrative embodiment. The example can be executed using application 222 in FIG. 2. Transcription module 310, candidate response generation module 320, and text to audio module 330 are the same as transcription module 310, candidate response generation module 320, and text to audio module 330 in FIG. 3. AR glasses 420 are the same as AR glasses 420 in FIG. 4.

As depicted, transcription module 310, executing in this example on AR glasses or a mobile device, generates translated transcription 512 from audio content 502. Translated transcription 512 is displayed on AR glasses 420 and sent to candidate response generation module 320. Candidate response generation module 320 uses an LLM to generate candidate responses 522, which are also displayed on AR glasses 420. Text to audio module 330, executing in this example on AR glasses or a mobile device, receives response selection 524 and generates translated audio content 532, which is audible to the person who spoke audio content 502 and in the same language as audio content 502 (even though translated transcription 512 and candidate responses 522 were not).

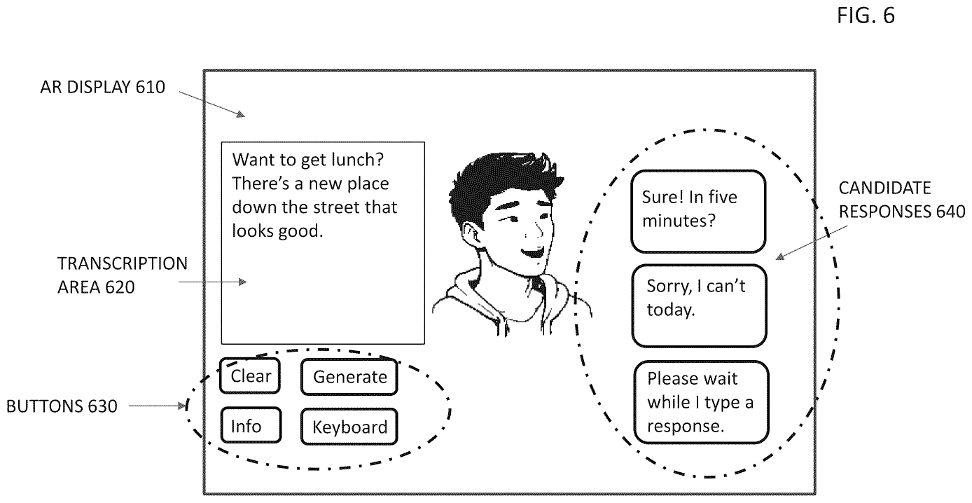

FIG. 6 depicts an example of contents of a display used in mixed reality device-based speech assistance, in accordance with an illustrative embodiment. The example can be executed using application 222 in FIG. 2.

As depicted, AR display 610 includes transcription area 620, including an example transcription of received audio content. Buttons 630 are examples of user interface elements usable to control functionality of application 222. Candidate responses 640 are examples of candidate responses to the transcription depicted in transcription area 620. Transcription area 620, buttons 630, and candidate responses 640 are virtual content that appears to be suspended in mid-air in front of the person a wearer of the AR glasses is looking at and conversing with.

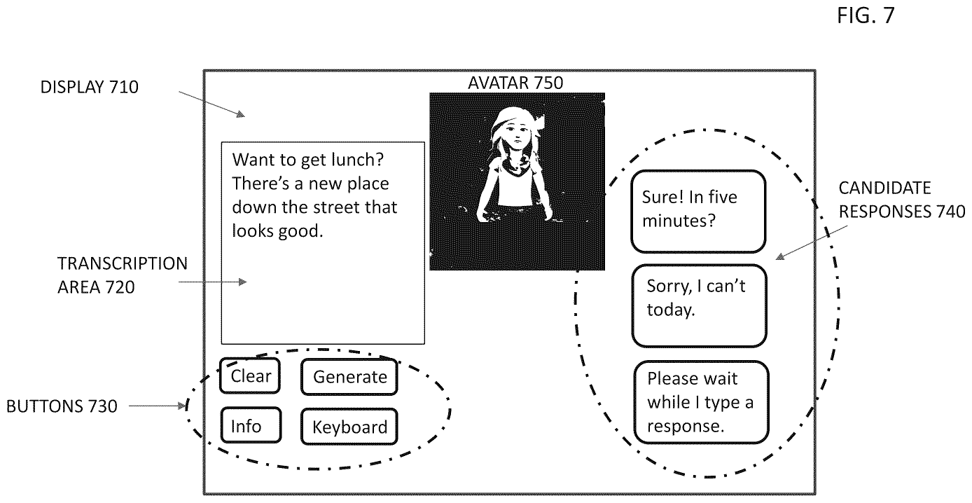

FIG. 7 depicts another example of contents of a display used in mixed reality device-based speech assistance, in accordance with an illustrative embodiment. The example can be executed using application 222 in FIG. 2.

As depicted, display 710 includes transcription area 720, including an example transcription of received audio content. Buttons 730 are examples of user interface elements usable to control functionality of application 222. Candidate responses 740 are examples of candidate responses to the transcription depicted in transcription area 720. Transcription area 720, buttons 730, and candidate responses 740 are virtual content, as is avatar 750, which appears to be speaking a selected response from candidate responses 740.

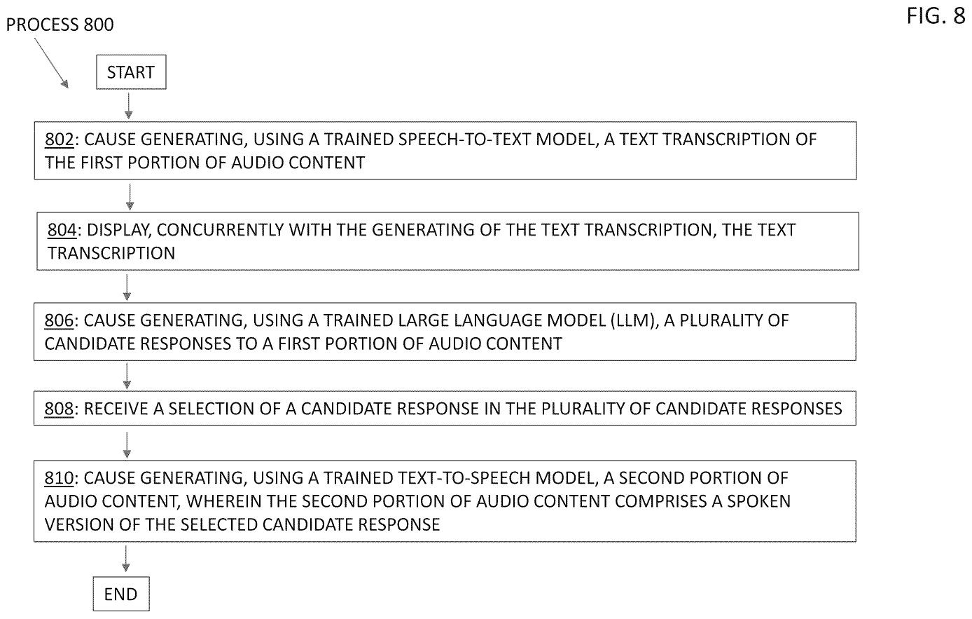

FIG. 8 depicts a flowchart of an example process for mixed reality device-based speech assistance, in accordance with an illustrative embodiment. Process 800 can be implemented in application 222 in FIG. 2.

At block 802, the process causes generating, using a trained speech-to-text model, a text transcription of the first portion of audio content. At block 804, the process displays, concurrently with the generating of the text transcription, the text transcription. At block 806, the process causes generating, using a trained LLM, a plurality of candidate responses to a first portion of audio content. At block 808, the process receives a selection of a candidate response in the plurality of candidate responses. At block 810, the process causes generating, using a trained text-to-speech model, a second portion of audio content, wherein the second portion of audio content comprises a spoken version of the selected candidate response. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
causing generating, using a trained large language model (LLM), a plurality of candidate responses to a first portion of audio content;
receiving a selection of a candidate response in the plurality of candidate responses; and
causing generating, using a trained text-to-speech model, a second portion of audio content, wherein the second portion of audio content comprises a spoken version of the selected candidate response.

2. The computer-implemented method of claim 1, further comprising:
causing generating, using a trained speech-to-text model, a text transcription of the first portion of audio content; and
displaying, concurrently with the generating of the text transcription, the text transcription.

3. The computer-implemented method of claim 2, wherein the text transcription is displayed on a display of a mixed reality device.

4. The computer-implemented method of claim 3, wherein the trained speech-to-text model executes on the mixed reality device.

5. The computer-implemented method of claim 3, wherein the trained speech-to-text model executes on a device other than the mixed reality device.

6. The computer-implemented method of claim 3, wherein the selection of the candidate response is performed using an eye movement tracker function of the mixed reality device.

7. The computer-implemented method of claim 3, wherein the second portion of audio content is generated on a device other than the mixed reality device.

8. The computer-implemented method of claim 1, further comprising:
causing generating, using a second trained speech-to-text model, a translated text transcription of the first portion of audio content, wherein the second trained speech-to-text model is trained to generate text in a first human language from input audio content in a second human language; and
displaying, concurrently with the generating of the translated text transcription, the translated text transcription.

9. The computer-implemented method of claim 1, wherein the plurality of candidate responses is each generated in text form.

10. The computer-implemented method of claim 1, wherein the plurality of candidate responses is each generated in audio form.

11. The computer-implemented method of claim 1, further comprising:
causing generating, using a trained avatar generation model, a portion of video content, wherein the portion of video content comprises an avatar portrayed as speaking the selected candidate response.

12. A non-transitory computer-readable medium storing a program, which when executed by a computer, configures the computer to:
cause generating, using a trained large language model (LLM), a plurality of candidate responses to a first portion of audio content;
receive a selection of a candidate response in the plurality of candidate responses; and
cause generating, using a trained text-to-speech model, a second portion of audio content, wherein the second portion of audio content comprises a spoken version of the selected candidate response.

13. The non-transitory computer-readable medium of claim 12, wherein the program, when executed by the computer, further configures the computer to:
cause generating, using a trained speech-to-text model, a text transcription of the first portion of audio content; and
display, concurrently with the generating of the text transcription, the text transcription.

14. The non-transitory computer-readable medium of claim 13, wherein the text transcription is displayed on a display of a mixed reality device.

15. The non-transitory computer-readable medium of claim 14, wherein the trained speech-to-text model executes on the mixed reality device.

16. The non-transitory computer-readable medium of claim 14, wherein the trained speech-to-text model executes on a device other than the mixed reality device.

17. The non-transitory computer-readable medium of claim 14, wherein the selection of the candidate response is performed using an eye movement tracker function of the mixed reality device.

18. The non-transitory computer-readable medium of claim 14, wherein the second portion of audio content is generated on a device other than the mixed reality device.

19. The non-transitory computer-readable medium of claim 12, wherein the program, when executed by the computer, further configures the computer to:
cause generating, using a second trained speech-to-text model, a translated text transcription of the first portion of audio content, wherein the second trained speech-to-text model is trained to generate text in a first human language from input audio content in a second human language; and
display, concurrently with the generating of the translated text transcription, the translated text transcription.

20. A system comprising:
a processor; and
a non-transitory computer-readable medium storing a set of instructions, which when executed by the processor, configure the system to:
cause generating, using a trained large language model (LLM), a plurality of candidate responses to a first portion of audio content;
receive a selection of a candidate response in the plurality of candidate responses; and
cause generating, using a trained text-to-speech model, a second portion of audio content, wherein the second portion of audio content comprises a spoken version of the selected candidate response.
